(19) United States
(12) Patent Application Publication
(10) Pub. No.: US 2023/0136211 A1
(43) Pub. Date: May 4, 2023

(54) INFORMATION SETTING CONTROL DEVICE AND METHOD, AND COMPUTER-READABLE STORAGE MEDIUM

(71) Applicants: NTT Communications Corporation, Tokyo (JP); 3i, Inc, Seoul (KR)

(72) Inventor: Ken KIM, Seoul (KR)

(73) Assignees: NTT Communications Corporation, Tokyo (JP); 3i, Inc, Seoul (KR)

(21) Appl. No.: 18/145,893

(22) Filed: Dec. 23, 2022

Related U.S. Application Data
(63) Continuation of application No. PCT/JP2021/018537, filed on May 17, 2021.

(30) Foreign Application Priority Data
Jul. 1, 2020 (JP) 2020-114294

(51) Int. Cl. G06F 3/14; G06T 15/00

(52) U.S. Cl. CPC G06F 3/14; G06T 15/00

(57) ABSTRACT

Even an attribute of a target object can be clearly confirmed while looking at a photographed image. According to one embodiment, where the user sets additional information for a 3D display image, a user terminal MT first displays first guide pattern in the process of specifying a setting target of the additional information, and then displays second guide information in the process of specifying the display position of the additional information. After the display position is determined, the additional information input by the user is registered in a server device SV in association with the setting target and the coordinates of the display position.

### CROSS REFERENCE TO RELATED APPLICATIONS

This application is a Continuation application of PCT Application No. PCT/JP2021/018537, filed May 17, 2021 and based upon and claiming the benefit of priority from Japanese Patent Application No. 2020-114294, filed Jul. 1, 2020, the entire contents of all of which are incorporated herein by reference.

### FIELD

Embodiments described herein relate generally to an information setting control device and method which are used for setting additional information to image information, and also to a non-transitory computer-readable storage medium which stores a program.

### BACKGROUND

In recent years, techniques have been proposed for managing facilities, such as business facilities, offices and residences using images. For example, Patent Literature 1 describes a technique in which a three-dimensional (3D) image showing the inside of a facility is generated by photographing a three-dimensional space of the facility in all directions (360°) at a plurality of different positions, recording the obtained images in a storage medium, and connecting the recorded images. The use of this technique enables a facility manager or a user to remotely grasp the state of the facility by looking at the 3D images without the need to go to the site.

### PATENT LITERATURE

Patent Literature 1: U.S. Patent Application Publication No. 2018/0075652

However, the conventionally proposed system generally displays a generated 3D image as it is. Thus, the user checks the state of the facility by relying only on the 3D image, and cannot check the attributes of the equipment or installations that make up the facility.

The present embodiment has been made with the above circumstances taken into consideration, and is intended to provide a technique that enables even the attributes of a target object to be confirmed while looking at a photographed image.

In order to solve the above-described problem, according to the first aspect, the information setting control device or information setting control method displays first guide information for designating a setting target of additional information in image data in a state where the image data which is obtained by photographing three-dimensional space of a photography target and which is being displayed, displays in the image data second guide information used for designating a display position in accordance with a user operation, displays in the image data third guide information which associates the setting target specified by the first guide information with the display position specified by the second guide information, and stores the additional information input by the user in a storage medium in association with information representing the display position.

According to the first aspect, the setting target and the display position of the additional information can be separately specified in the image data. Therefore, the additional information can be displayed without the setting target being hidden. Moreover, since the setting target and display position of the additional information are associated with each other by the third guide information, the additional information can be displayed in a state in which it is clearly associated with the setting target.

That is, according to one aspect, it is possible to provide a technique that enables even the attributes of an object to be clearly confirmed while viewing a photographed image.

### BRIEF DESCRIPTION OF THE DRAWINGS

FIG. 1 is a schematic configuration diagram of a system including a user terminal and a server device that operate as an information setting control device according to one embodiment.

FIG. 2 is a block diagram showing an example of a hardware configuration of the user terminal of the system shown in FIG. 1.

FIG. 3 is a block diagram showing an example of a software configuration of the user terminal of the system shown in FIG. 1.

FIG. 4 is a block diagram showing an example of a hardware configuration of the server device of the system shown in FIG. 1.

FIG. 5 is a block diagram showing an example of a software configuration of the server device of the system shown in FIG. 1.

FIG. 6 is a flowchart showing an example of the processing procedures and processing contents illustrating how additional information setting control is performed by the user terminal shown in FIG. 3.

FIG. 7 is a flowchart showing an example of the processing procedures and processing contents illustrating how additional information is registered and output by the server device shown in FIG. 5.

FIG. 8 is a diagram showing an example of first guide information displayed by the additional information setting control shown in FIG. 6.

FIG. 9 is a diagram showing an example of second guide information and third guide information displayed by the additional information setting control shown in FIG. 6.

FIG. 10 is a diagram showing a first example of an input template for additional information.

FIG. 11 is a diagram showing a second example of an input template for additional information.

FIG. 12 is a diagram illustrating a display example of image data in which third guide information is displayed.

FIG. 13 is a diagram illustrating an example of a display result of additional information.

### DETAILED DESCRIPTION

Embodiments will now be described with reference to the accompanying drawings.

### One Embodiment

### Configuration Example

(1) System

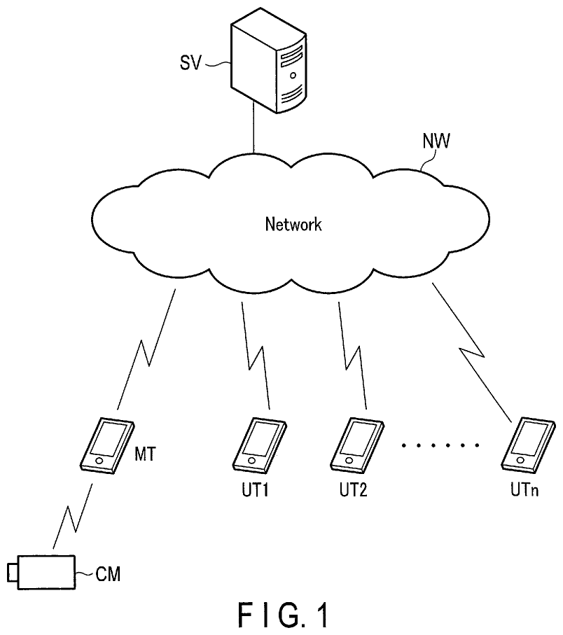

FIG. 1 is a schematic configuration diagram of a 3D image management system according to one embodiment. This system includes user terminals MT and UT1-UTn and a server device SV. Data communications are enabled between the server device SV and user terminals MT and UT1 to UTn via a network NW.

Of the user terminals MT and UT1 to UTn, the user terminal MT is mainly used for registering omnidirectional images and additional information. On the other hand, the user terminals UT1 to UTn are used for browsing 3D images and additional information generated based on the registered omnidirectional images. Of the user terminals, the user terminal MT constitutes an information setting control device according to one embodiment together with the server device SV.

In this example, each of the user terminals MT and UT1 to UTn is composed of a portable information terminal such as a smartphone or a tablet type terminal. It should be noted that a notebook personal computer or a desktop personal computer may be used as a user terminal UT1 to UTn.

The network NW is composed of an IP network including the Internet and an access network for accessing this IP network. For example, a public wired network, a mobile phone network, a wired Local Area Network (LAN), a wireless LAN, Cable Television (CATV), etc. are used as the access network.

(2) Device

(2-1) User Terminal MT

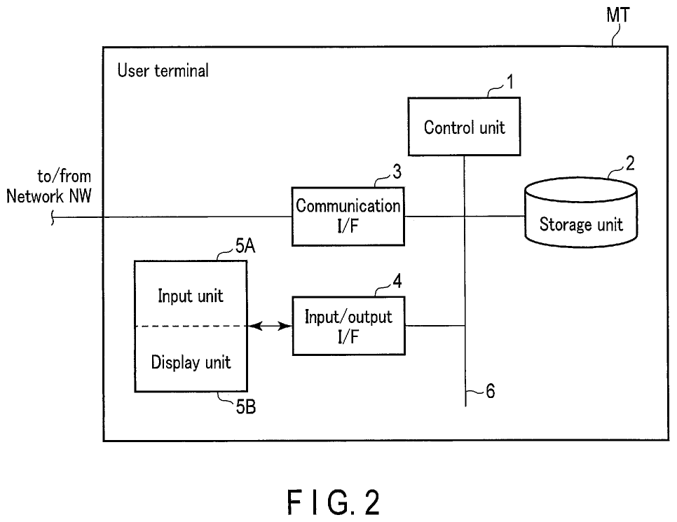

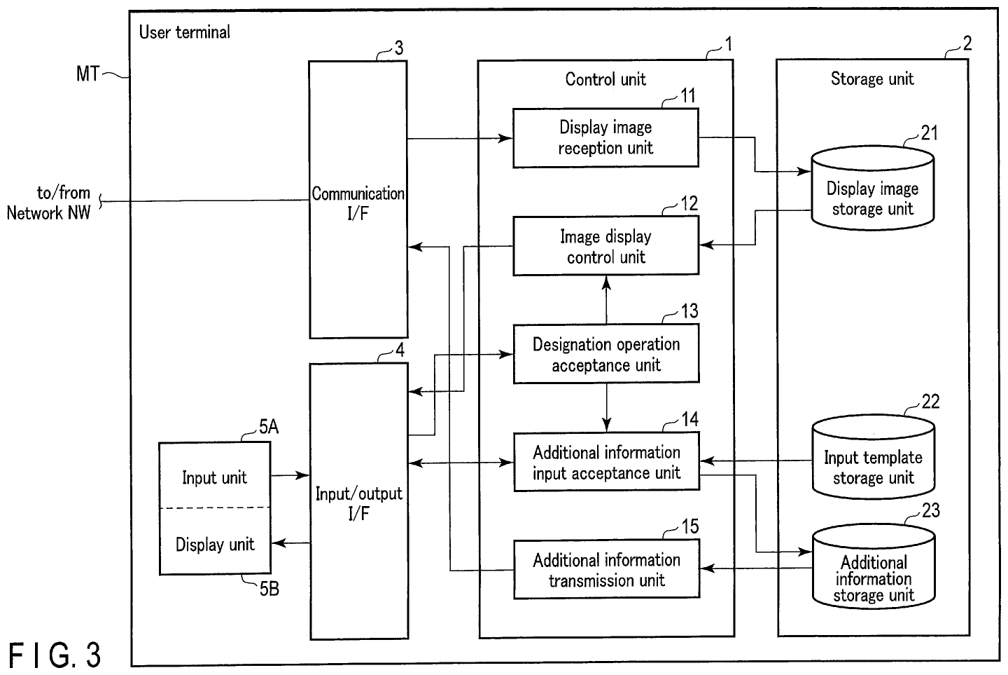

FIGS. 2 and 3 are block diagrams that show the hardware configuration and software configuration of the user terminal MT, respectively.

The user terminal MT includes a control unit 1 having a hardware processor such as a central processing unit (CPU). A storage unit 2, a communication interface (communication I/F) 3 and an input/output interface (input/output I/F) 4 are connected to the control unit 1 via a bus 6.

The communication I/F 3 includes a radio interface for transmitting and receiving data to and from the server device SV via the network NW under the control of the control unit 1. The communication I/F 3 also include a camera interface for communicating with the camera CM. The camera interface adopts a low-power wireless data communication standard such as Bluetooth (registered trademark). It should be noted that the camera CM and the communication I/F 3 can be connected via a signal cable such as a Universal Serial Bus (USB) cable.

The camera CM is a camera capable of photographing in all directions, and is fixed, for example, to a tripod capable of maintaining a constant height position. The camera CM transmits photographed omnidirectional image data to the user terminal MT. A camera built in the user terminal MT can be substituted for the camera CM.

The communication I/F 3 may include an interface for receiving, for example, Global Positioning System (GPS) signals and signals transmitted from wireless LAN access points. This interface enables the user terminal MT to detect its own current position.

An input unit 5A and a display unit 5B are connected to the input/output I/F 4. The input unit 5A and the display unit 5B are tablet-type devices in which an input detection sheet using a pressure-sensitive or electrostatic capacitance detection method is arranged on a display device such as liquid crystal or organic EL. The input/output I/F 4 notifies the control unit 1 of operation information detected by the input unit 5A, and displays display data output from the control unit 1 on the display unit 5B.

The storage unit 2 uses, for example, a nonvolatile memory, such as a Solid State Drive (SSD), which serves as a main storage medium and for which data can be written and read at any time. As the storage medium, a combination of a Hard Disk Drive (HDD), a Read Only Memory (ROM) and a Random Access Memory (RAM) may be used in addition to the SSD or in place of the SSD.

A program storage area and a data storage area are provided in the storage area of the storage unit 2. In addition to middleware such as an Operating System (OS), the program storage area stores an application program necessary for executing control processing according to one embodiment.

In the data storage area, a display image storage unit 21, an input template storage unit 22, and an additional information storage unit 23 are provided as storage units necessary for carrying out one embodiment. The display image storage unit 21 is used to store 3D display image data downloaded from the server device SV. The input template storage unit 22 stores an input template for guiding the input operation of additional information. The additional information storage unit 23 is used to store additional information input by the user through the input unit 5A.

The control unit 1 includes, as control processing functions according to one embodiment, a display image reception unit 11, an image display control unit 12, a designation operation acceptance unit 13, an additional information input acceptance unit 14, and an additional information transmission unit 15. Each of these processing units 11 to 15 is implemented by causing a hardware processor to execute an application program stored in the program storage area of the storage unit 2.

The display image reception unit 11 accesses the server device SV in response to the browsing operation of the user, receives the 3D display image data downloaded from the server device SV via the communication I/F 3, and stores the received 3D display image data in the display image storage unit 21.

The image display control unit 12 reads 3D display image data from the display image storage unit 21 in accordance with the user's angle selection operation, outputs the read 3D display image data to the input/output I/F 4, and displays it on the display unit 5B.

Where the user designates an operation for designating a setting target and a display position of the additional information by operating a mouse in the state where the 3D display image data is displayed on the display unit 5B, the designation operation acceptance unit 13 displays first guide information for designating the setting target, second guide information for designating the display position and third guide information for associating the setting target and the display position with each other, such that the first, second and third guide information are synthesized with the 3D display image. An example of each guide information will be described later.

Where the user performs an operation to determine the display position of the additional information, the additional information input acceptance unit 14 reads the input template data of the additional information from the input template storage unit 22, and displays the input template data on the display unit 5B via the input/output I/F 4. According to the displayed input template data, the additional information input by the user through the input unit 5A is acquired through the input/output I/F 4, and the acquired additional information is stored in the additional information storage unit 23 in association with coordinate information indicating the setting target and display position of the additional information.

Where the additional information setting process for the currently-browsed 3D display image data is completed, the additional information transmission unit 15 reads the additional information from the additional information storage unit 23 together with coordinate information indicating the setting target and display position of the additional information, and transmits an additional information registration request from the communication I/F 3 to the server device SV, together with the read additional information and coordinate information.

(2-2) Server Device SV

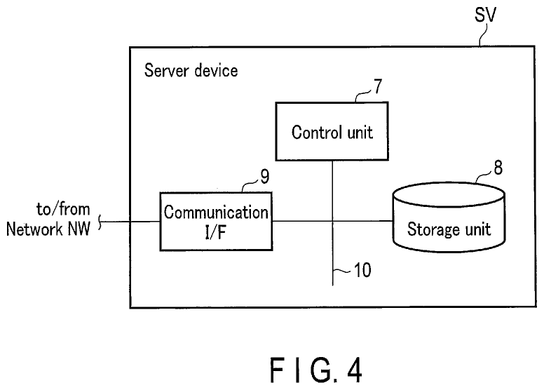

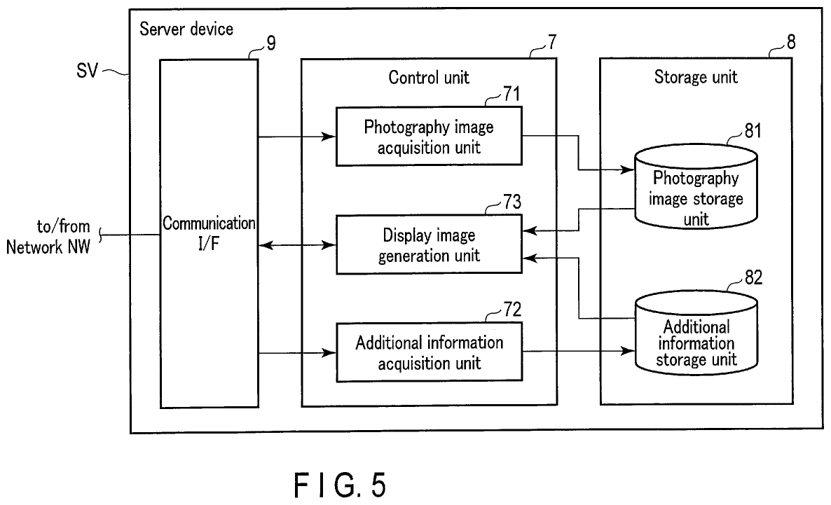

FIGS. 4 and 5 are block diagrams that show the hardware and software configurations of the server device SV, respectively.

The server device SV is composed of a server computer installed on the cloud or the Web, and includes a control unit 7 having such a hardware processor as a CPU. A storage unit 8 and a communication interface (communication I/F) 9 are connected to the control unit 7 via a bus 10.

The communication I/F 9 transmits and receives data to and from the user terminals MT and UT1 to UTn via the network NW under the control of the control unit 7, and uses a wired network interface, for example.

The storage unit 8 uses, for example, a nonvolatile memory, such as an HDD or an SSD, which serves as a main storage medium and for which data can be written and read at any time. As the storage medium, a ROM and a RAM may be used in combination.

A program storage area and a data storage area are provided in the storage area of the storage unit 8. Programs necessary for executing various control processes related to one embodiment are stored in the program storage area, in addition to middleware such as an OS.

In the data storage area, a photography image storage unit 81 and an additional information storage unit 82 are provided as storage units necessary for carrying out one embodiment. In addition, a work storage unit necessary for various processes executed by the control unit 7 is provided.

The photography image storage unit 81 is used to store all omnidirectional images transmitted from the user terminal MT in association with information representing the photographing dates and times and the photographing positions. The additional information storage unit 82 is used to store additional information sent from the user terminal MT and coordinate information indicating a setting target and a display position of the additional information.

The control unit 7 includes a photography image acquisition unit 71, an additional information acquisition unit 72 and a display image generation unit 73 as control processing functions according to one embodiment. Each of these processing units 71 to 73 is implemented by causing a hardware processor to execute a program stored in the program storage area of the storage unit 8.

Each time the photography image data including omnidirectional images photographed with the camera CM is sent from the user terminal MT, the photography image acquisition unit 71 receives the photography image data via the communication I/F 9, and stores the received photography image data in the photography image storage unit 81 in association with information representing the photographing position coordinates and the photographing dates and times which are received together with the image data.

Where an additional information registration request is sent from the user terminal MT, the additional information acquisition unit 72 stores the additional information included in the request and the coordinate information indicating the setting target and display position of the additional information in the additional information storage unit 82.

The display image generation unit 73 has the following processing functions.

(1) Where an image browsing request is sent from the user terminals MT and UT1 to UTn, the omnidirectional image data corresponding to the floor of the facility specified by the browsing request is read from the photography image storage unit 81, and 3D display image data is generated. The generated 3D display image data is transmitted from the communication I/F 9 to the request-making user terminals MT and UT1 to UTn.

(2) A determination is made to see whether or not additional information is registered for the 3D display image data. Where the additional data is registered, coordinate information indicating the setting target of the additional information and the display positions is read from the additional information storage unit 82. Third guide information is generated from the coordinate information and is synthesized with the 3D display image data.

(3) Where a request for displaying additional information is sent from a user terminal MT and UT1 to UTn which is browsing the 3D display image, additional information is read from the additional information storage unit 82, based on the coordinates indicating the additional information display position included in the request. The read additional information is synthesized with the currently-browsed 3D display image, and the 3D display image data including the synthesized additional information is transmitted from the communication I/F 9 to the request-making user terminals MT and UT1 to UTn.

### Operation Example

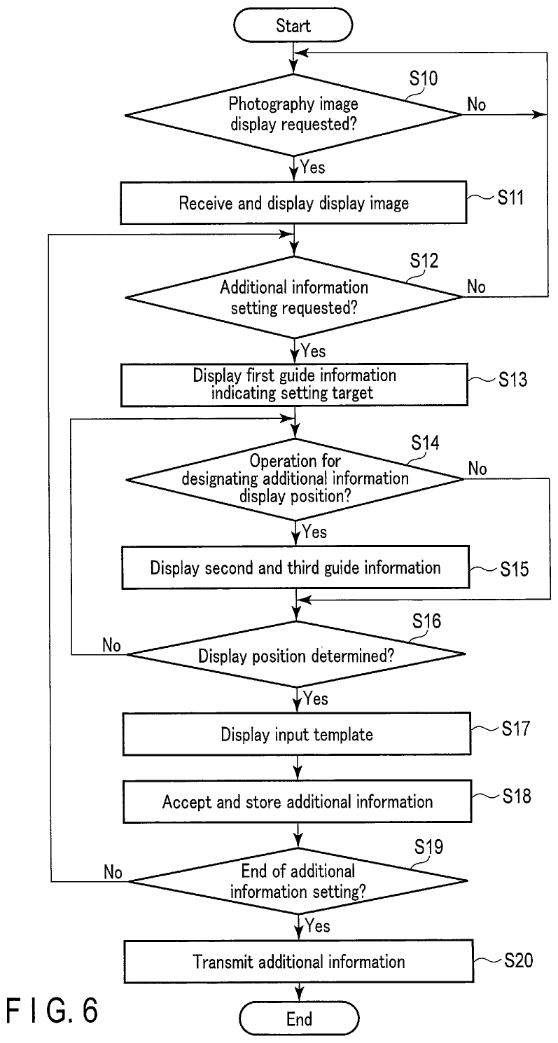

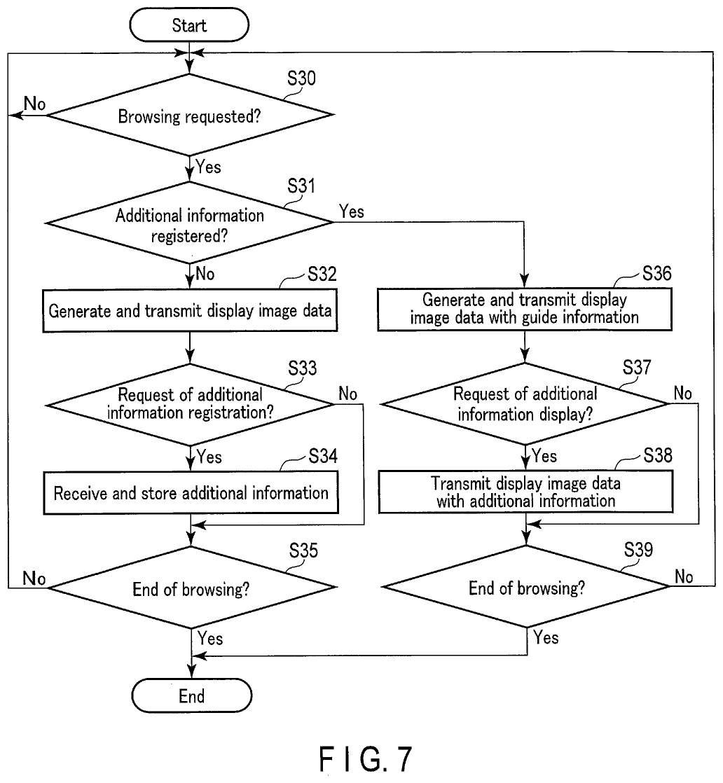

Next, an operation example of the user terminal MT and the server device SV configured as described above will be described. FIG. 6 and FIG. 7 are flowcharts showing an example of the processing procedures and processing contents.

A description will be given on the assumption that the omnidirectional image data of the target floor is already stored in the photography image storage unit 81 of the server device SV.

(1) Browsing of 3D Images

Where the user intends to browse 3D images of a desired facility and floor and access the server device SV and designates a target facility and its floor, the user terminal MT detects this operation in step S10, and transmits a photography image browsing request to the server device SV.

On the other hand, where the server device SV detects reception of the browsing request from the user terminal MT in step S30, the server device SV first determines, in step S31 under the control of the display image generation unit 73, whether additional information is already registered in the image of the floor for which the browsing request is made, based on the information stored in the additional information storage unit 82. Where the additional information has not yet been registered, all omnidirectional images corresponding to the floor are read from the photography image storage unit 81 to generate 3D display image data in step S32. The generated 3D display image data is sent from the communication I/F 9 to the request-making user terminal MT.

Under the control of the display image reception unit 11, the user terminal MT receives the 3D display image data transmitted from the server device SV via the communication I/F 3 in step S11 and temporarily stores it in the display image storage unit 21. In step S11, under the control of the image display control unit 12, the 3D display image data is read from the display image storage unit 21 and is output to the input/output I/F 4 and displayed on the display unit 5B. If, at the time, the user operates the input unit 5A and performs an operation to change the display angle of the image, the display angle of the 3D display image is changed according to the operation. Therefore, the user can selectively browse the 3D images of a desired location on the floor. Thus, a 3D image tour of the floor is enabled.

(2) Designation of Setting Target and Display Position of Additional Information

Let it be assumed that in a state where an image of a desired room on a floor is displayed by the 3D image tour, the user designates a position or facility as a setting target by operating a mouse in order to set additional information representing an attribute for the desired position or facility in the display image.

Upon detection of the additional information setting request in step S12, the user terminal MT executes processing for permitting the user to accept the designation of the setting target and display position of the additional information as follows under the control of the designation operation acceptance unit 13.

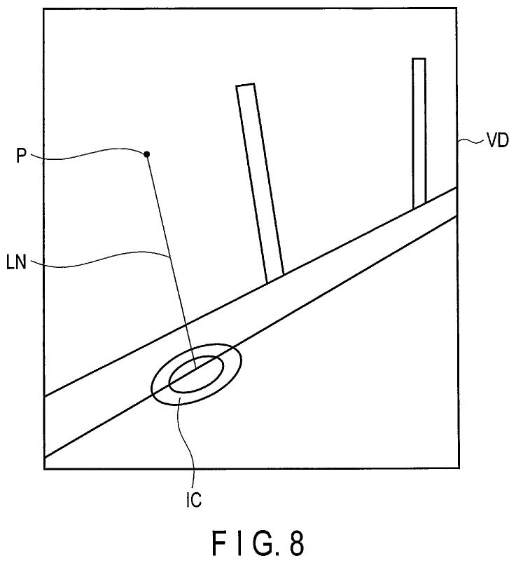

That is, in step S13, the designation operation acceptance unit 13 first displays a ring-shaped reference pattern IC at a reference position in the display image VD, for example, at a position indicating the floor surface, and draws a linear pattern LN vertically above the reference pattern IC, as shown in FIG. 8. The reference pattern IC and the linear pattern LN constitute first guide information.

In this state, if the user lengthens or shortens the linear pattern LN by operating the mouse, such that the leading end portion P of the linear pattern LN comes to a position for which additional information is to be set (for example, a wall surface in the image), the designation operation acceptance unit 13 stores the position coordinates of the leading end portion P as coordinate information indicating the position of the setting target of the additional information.

Next, in order to specify the display position of the additional information, the user moves the reference pattern IC to a position directly below the display position of the additional information, for example, by operating the mouse, and then lengthens or shortens the linear pattern LN, which extends upward from the reference pattern IC, such that the leading end portion comes to the display position of the additional information.

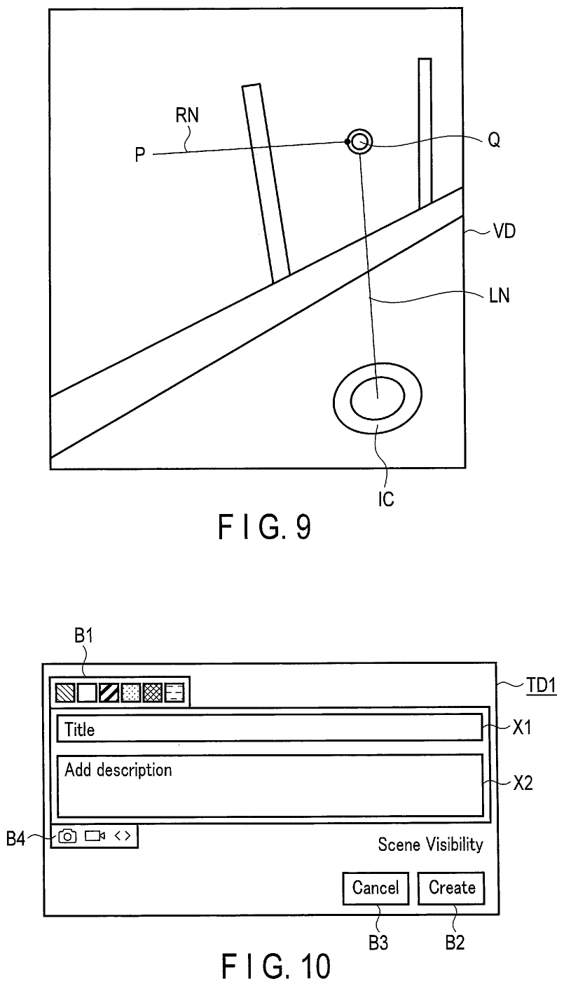

At this time, where the designation operation acceptance unit 13 detects the designating operation of the display position in step S14, the display positions of the reference pattern IC and the linear pattern LN are horizontally moved to a position immediately below the display position of the additional information on the display image VD in step S15, as shown in FIG. 9. The reference pattern IC and linear pattern LN constitute second guide information.

Where the leading end portion of the linear pattern LN is stopped at the display position of the additional information by the lengthening or shortening operation of the linear pattern LN, the designation operation acceptance unit 13 displays a mark pattern Q at the stopped position indicating that the display position of the additional information is displayed, and draws a leader line pattern RN connecting between the mark pattern Q and the previously designated setting target position P of additional information. The mark pattern Q and leader line pattern RN constitute third guide information.

(3) Input of Additional Information

Where the display position of the additional information is determined by the designation operation, and this determining operation is detected in step S16, the user terminal MT first reads input template data from the input template storage unit 22 in step S17 under the control of the additional information input acceptance unit 14, outputs the read input template data to the input/output I/F 4 and displays it on the display unit 5B.

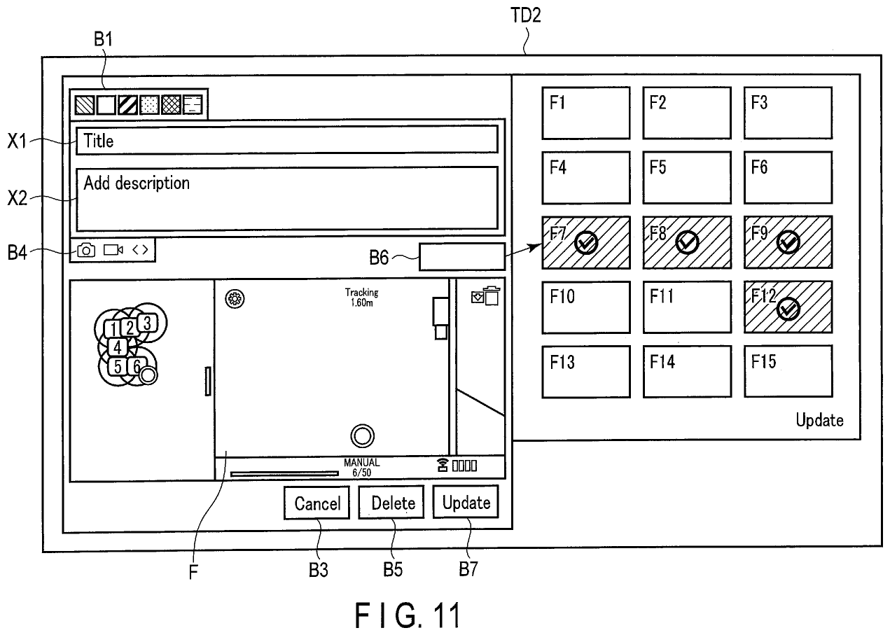

FIG. 10 shows a first example of an input template. The template TD1 shown in FIG. 10 includes a title input area X1 and an additional information input area X2. B1, B2, B3 and B4 denote a background color setting button, a create button, a cancel button and an image selection button, respectively. FIG. 11 shows an example of a setting result of additional information that is displayed in the template TD2 where the “Scene Visibility” button B6 is operated in the template shown in FIG. 10.

Where the user inputs additional information by operating the input unit 5A in accordance with the input template, the additional information input acceptance unit 14 accepts the input of the additional information in step S17, and stores the input additional information in the additional information storage unit 23. At this time, the additional information input acceptance unit 14 associates coordinate information on the image data representing the setting target and the display position of the additional information detected by the designation operation acceptance unit 13 with the additional information, and stores the resultant coordinate information in the additional information storage unit 23.

(4) Registration of Additional Information

Let it be assumed that the input of the additional information is completed and the user clicks the update button B7 of the input template. Under the control of the additional information transmission unit 15, the user terminal MT detects an operation of the update button B7 in step S19, and subsequently in step S20, reads the additional information and coordinate information indicating a setting target and a display position of the additional information from the additional information storage unit 23, and transmits an additional information registration request in which the read additional information and coordinate information are included, from the communication I/F 3 to the server device SV.

It should be noted that the transmission process of the additional information and each coordinate information may be performed each time one piece of additional information is set, or may be performed collectively when the setting of additional information for one image or all images of one floor is completed.

Where reception of the additional information registration request is detected in step S33 under the control of the additional information acquisition unit 72, the server device SV receives the additional information and the coordinate information via the communication I/F 9 in step S34, and stores the received additional information and coordinate information in the additional information storage unit 82.

The server device SV executes transmission processing of the 3D display image and registration acceptance processing of the additional information in steps S30 to S34 until a browsing end operation is detected in step S35.

(5) Browsing of 3D Images with Additional Information

By way of example, let it be assumed that the user terminals UT1 to UTn transmit a browsing request for browsing 3D images of a facility and its floors to the server device SV. Upon detection of the browsing request in step S30, the server device SV first determines, in step S31 under the control of the display image generation unit 73, whether additional information is already registered in the image of the floor requested by the browsing request on the basis of the information stored in the additional information storage unit 82. If the additional information is registered, the following browsing response processing is executed.

That is, the display image generation unit 73 first generates 3D display image data with guide information in step S36. This display image data is generated, for example, by first reading all omnidirectional images corresponding to the floor specified by the browsing request from the photography image storage unit 81, to generate the 3D display image data. Next, third guide information is generated based on the coordinate information stored in the additional information storage unit 82 and indicating the setting target and display position of the additional information set corresponding to the 3D display image. This third guide information is the same as the mark pattern Q generated by the user terminal MT at the time of setting additional information and indicating the display position, and the leader line pattern RN that associates the display position with the setting target.

Then, the display image generation unit 73 synthesizes the generated third guide information with the corresponding coordinate position in the 3D display image data, and transmits the generated 3D display image data with the guide information to the request-making user terminals UT1-UTn via the communication I/F 9.

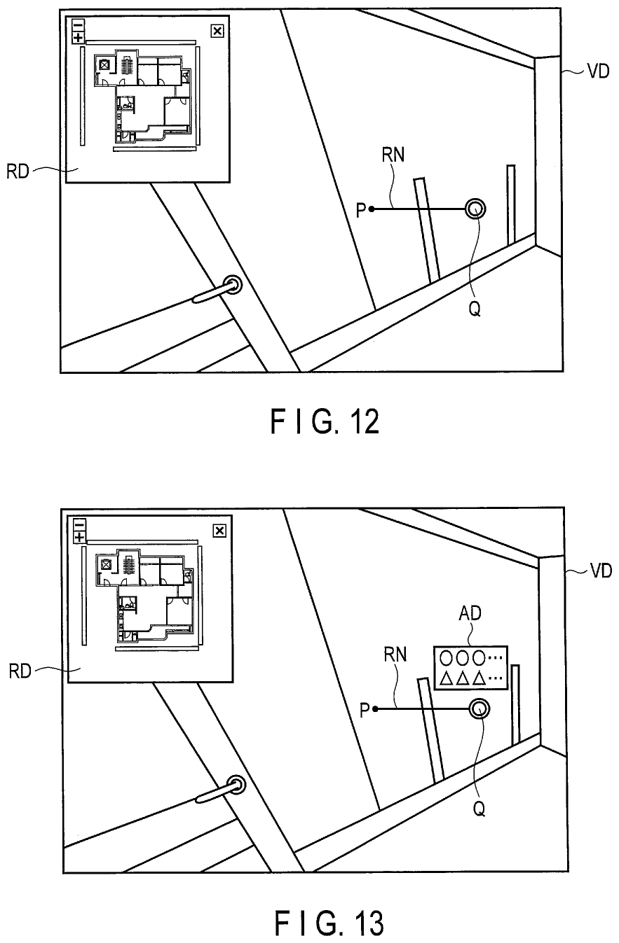

Under the control of the display image reception unit 11, the user terminal MT receives the 3D display image data with guide information transmitted from the server device SV via the communication I/F 3 in step S11 and temporarily stores it in the display image storage unit 21. In step S11, under the control of the image display control unit 12, the 3D display image data is read from the display image storage unit 21 and is output to the input/output I/F 4 and displayed on the display unit 5B. FIG. 12 shows an example of how 3D display image data VD with guide information is displayed on the display unit 5B. As shown in this example, the 3D display image data VD includes a mark pattern Q indicating a display position of additional information and a leader line pattern RN that associates the display position with a setting target of the additional information.

Let it be assumed that in this state the user designates the mark pattern Q by operating the mouse in order to confirm the additional information set for a member indicated by the leader line pattern RN. In response to this, the display request of the additional information is transmitted from the user terminals UT1 to UTn to the server device SV.

Upon reception of the display request in step S37, the server device SV selectively reads additional information corresponding to the display position coordinates included in the display request from the additional information storage unit 82 under the control of display image generation unit 73 in step S38. The read additional information is synthesized with the display position of the 3D display image data currently transmitted to the user terminals UT1 to UTn, and the 3D display image data synthesized with the additional information is transmitted to the request-making user terminal UT1-UTn.

Under the control of the image display control unit 12, the user terminals UT1 to UTn display the received 3D display image data with additional information on the display unit 5B via the input/output I/F 4. FIG. 13 shows an example of 3D display image data with additional information displayed at this time, where AD indicates the additional information. It should be noted that FIGS. 12 and 13 illustrate the case where a plan view RD of the floor on which the photographing positions of the 3D display image are plotted is displayed on the 3D display image.

### Operations and Advantageous Effects

As described above, according to one embodiment, where the user sets additional information for a 3D display image, the user terminal MT first displays first guide pattern in the process of specifying a setting target of the additional information, and then displays second guide information in the process of specifying the display position of the additional information. After the display position is determined, additional information the user inputs according to an input template is registered in the server device SV in association with the coordinates of the setting target and the display position. Where the 3D image for which the additional information is set is displayed, third guide information indicating the setting target and the display position of the additional information is displayed on the 3D image, and in this state, the user designates the display position according to the third guide information. By doing so, the corresponding additional information is displayed at the display position of the 3D image.

Therefore, additional information can be set where necessary, for the members and equipment shown in the 3D image, so that the user can confirm details of the members and equipment using the additional information while performing a browsing tour of the floor using the 3D images.

In addition, in the setting operation of additional information, a display position is designated at a position different from that of the setting target in the 3D image, and the additional information is registered in association with this display position. It is therefore possible to prevent the problem in which the setting target is hidden by the additional information and cannot be confirmed when the additional information is displayed on the 3D image.

Furthermore, during the setting operation of the additional information, the first and second guide information is displayed on the 3D image, so that the setting target and display position of the additional information can be clearly displayed. After the end of the setting of the additional information, the first and second guide information is erased and only the third information is displayed. Thus, the operability at the time of setting the additional information can be enhanced, and yet the visibility of the 3D image can be improved.

### OTHER EMBODIMENTS

(1) In connection with one embodiment, reference was made to the case where the display control of the first and second guide information according to the designation operation of the setting target and display position of the additional information is executed on the side of the user terminal MT. This, however, is not restrictive, and display control of the guide information according to the designation operation may be executed on the side of the server device SV. If this is done, there may be a concern that responsiveness may be degraded due to a transmission delay between the user terminal MT and the server device SV, but a new application need not be installed in the user terminal MT, and the processing load on the user terminal MT can be reduced.

(2) According to one embodiment, the setting target and the display position of the additional information are designated such that the leading end portion P of the linear pattern LN is aligned with them. Instead of this, a character pattern such as an arrow or a star may be displayed at specified positions. By doing so, the designated position can be displayed more clearly. In addition, the configuration of the first, second and third guide information, and the size and color of the display pattern, etc. may be set in any manner desired.

(3) The display position of the additional information may be changed after the additional information is set. By doing so, the display size of the additional information and the shape of the balloon can be set at more optimal display positions in accordance with the content of the 3D image, etc. In addition, the format of the additional information, the type of information, the amount of information, etc. may be set in any way.

(4) Additional information may include, for example, link destination information on a website that stores more detailed information and related information of the additional information, so that the website can be accessed based on this link destination information. In this way, the browsing user can easily obtain more detailed information and related information regarding the members and equipment while browsing the 3D display image.

(5) In addition, the configuration of the information setting control device, control processing procedures, processing contents, etc. can be modified in various ways without departing from the gist.

Although the embodiments have been described in detail, the above description is merely illustrative in every respect. Needless to say, various improvements and modifications can be made without departing from the scope. That is, in implementing the present invention, a specific configuration according to the embodiments may be appropriately adopted.

The present invention is not limited to the above-described embodiments and can be embodied in practice by modifying the structural elements without departing from the gist of the invention. In addition, various inventions can be made by properly combining the structural elements disclosed in connection with the above embodiments. For example, some of the structural elements may be deleted from each of the embodiments. Furthermore, structural elements of different embodiments may be combined properly.

### REFERENCE SIGNS LIST

SV: server device
MT, UT1-UTn: user terminal
NW: network
CM: camera
1, 7: control unit
2, 8: storage unit
3, 9: communication I/F
6, 10: bus
11: display image reception unit
12: image display control unit
13: designation operation acceptance unit
14: additional information input acceptance unit
15: additional information transmission unit
21: display image storage unit
22: input template storage unit
23: additional information storage unit
71: photography image acquisition unit
72: additional image acquisition unit
73: display image generation unit
81: photography image storage unit
82: additional image storage unit

What is claimed is:

1. An information setting control device comprising:
a first display control unit configured to display first guide information for designating a setting target of additional information in image data obtained by photographing a three-dimensional space, in a state where the image data is being displayed;
a second display control unit configured to display second guide information, which is used for designating a display position of the additional information, in the image data in accordance with an operation of a user;
a third display control unit configured to display third guide information in the image data, the third guide information associating the setting target designated by the first guide information with the display position designated by the second guide information; and
an additional information acquisition unit configured to store the additional information input by the user in a storage medium in association with information representing the display position.

2. The information setting control device according to claim 1, wherein the first guide information and the second guide information respectively include a reference pattern displayed at a reference position of the image data, and a linear pattern extendably lead from the reference pattern to the setting target and the display position of the additional information.

3. The information setting control device according to claim 1, wherein the third guide information includes a mark pattern displayed at the display position of the additional information, and a leader line pattern connecting between the setting target of the additional information and the mark pattern.

4. The information setting control device according to claim 1, wherein the first display control unit and the second display control unit respectively erase the first guide information and the second guide information after a process of storing the additional information is ended.

5. The information setting control device according to claim 1, wherein the additional information acquisition unit displays an input template for inputting the additional information, and acquires the additional information input according to the input template.

6. The information setting control device according to claim 3, further comprising:
a fourth display control unit configured to read the additional information stored in association with the display position specified by the mark position from the storage medium where an operation for designating the mark pattern is performed in a state in which the image data including the third guide information is being displayed, and to display the read additional information at the display position of the image data.

7. An information setting control method executed by an information processing device, comprising:
displaying first guide information for designating a setting target of additional information in image data obtained by photographing a three-dimensional space of a photography target, in a state where the image data is displayed;
displaying second guide information, which is used for designating a display position of the additional information, in the image data in accordance with an operation of a user;
displaying third guide information in the image data, the third guide information associating the setting target designated by the first guide information with the display position designated by the second guide information; and
acquiring the additional information input by the user and storing the acquired additional information in a storage medium in association with information representing the display position specified by the second guide information.

8. A non-transitory computer-readable storage medium storing programs for causing a processor of the information setting control device recited in claim 1 to execute a process of each unit of the information setting control device.

9. A non-transitory computer-readable storage medium storing programs for causing a processor of the information setting control device recited in claim 2 to execute a process of each unit of the information setting control device.

10. A non-transitory computer-readable storage medium storing programs for causing a processor of the information setting control device recited in claim 3 to execute a process of each unit of the information setting control device.

11. A non-transitory computer-readable storage medium storing programs for causing a processor of the information setting control device recited in claim 4 to execute a process of each unit of the information setting control device.

12. A non-transitory computer-readable storage medium storing programs for causing a processor of the information setting control device recited in claim 5 to execute a process of each unit of the information setting control device.

13. A non-transitory computer-readable storage medium storing programs for causing a processor of the information setting control device recited in claim 6 to execute a process of each unit of the information setting control device.
